(19) United States
(12) Patent Application Publication
(10) Pub. No.: US 2005/0154989 A1
(43) Pub. Date: Jul. 14, 2005

(54) User interface for a storage network

(76) Inventors: Steven Maddocks, Windsor, CO (US); Jeffrey Dicorpo, San Carlos, CA (US); Gregory Turpin, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/757,762

(22) Filed: Jan. 14, 2004

(51) Int. Cl. G06F 3/00; G06F 9/00; G06F 17/00

(52) U.S. Cl. 715/735

(57) ABSTRACT

User interface for a storage network and methods of operation. In an exemplary implementation, a storage network comprises an automated storage system including data access drives and transfer robotics. An interface manager is communicatively coupled to each of the data access drives and transfer robotics, the interface manager aggregating configuration information for the data access drives and transfer robotics in the automated storage system. An interface application is provided in computer-readable storage at the interface manager, the interface application generating user interface rendering data for the configuration information. A graphical user interface is operatively associated with the interface application, the graphical user interface outputting the configuration information in accordance with the user interface rendering data.

### RELATED APPLICATION

This application is related to co-owned U.S. Patent Application for “INTERFACE MANAGER AND METHODS OF OPERATION IN A STORAGE NETWORK” of Maddocks et al. (Attorney Docket No. HP1-707US; Client Docket No. HP200315416-1), filed the same day as the present application.

### TECHNICAL FIELD

This invention relates to automated storage systems in general, and more specifically, to user interfaces for storage networks.

### BACKGROUND

Automated storage systems are commonly used to store large volumes of data on various types of storage media, such as magnetic tape cartridges, optical storage media, and hard disk drives, to name only a few examples. System devices in the storage system can be logically configured or “mapped” for user access over a network. For example, the users may be given access to one or more data access drives, for read and/or write operations, and to transfer robotics to move the storage media between storage cells and the data access drives.

In order to logically map the storage system, a network administrator needs the configuration or physical layout of the storage system. The network administrator, for example, may have to trace the physical cables from each of the system devices to the internal routers that control the system devices. Next, the network administrator connects to the storage system via an out-of-band interface (e.g., a telnet command prompt) to generate a logical map that allows user access to the various system devices. The logical map is then assigned to a host connection that facilitates user access to the storage system. This process can be time-consuming and error prone, particularly in large storage systems that have more than one internal router with many system devices that need to be configured.

In addition, the network administrator has to generate a new logical map for each host connection. Alternatively, the network administrator may configure a default map that can be assigned to all or some of the host connections. However, assigning the same default map to more than one host connection may result in conflicting commands being issued to the system devices. For example, one host connection may issue a “rewind” command to a drive while another host connection is using the same drive for a backup operation.

### SUMMARY

An exemplary storage network comprises an automated storage system including data access drives and transfer robotics. An interface manager is communicatively coupled to each of the data access drives and transfer robotics, the interface manager aggregating configuration information for the data access drives and transfer robotics in the automated storage system. An interface application is provided in computer-readable storage at the interface manager, the interface application generating user interface rendering data for the configuration information. A graphical user interface is operatively associated with the interface application, the graphical user interface outputting the configuration information in accordance with the user interface rendering data.

In an exemplary automated storage system linked to a graphical user interface including a display and a user interface selection device, a method may comprise: aggregating configuration information at an interface manager for a plurality of system devices in the automated storage system, generating user interface rendering data at the interface manager, and displaying the configuration information in an application window at the graphical user interface in accordance with the user interface rendering data.

An exemplary method of operation comprises: aggregating configuration information for a plurality of system devices in a storage system, generating user interface rendering data, and displaying the configuration information as a logical map of the system devices at a graphical user interface in accordance with the user interface rendering data.

### BRIEF DESCRIPTION OF THE DRAWINGS

FIG. 1 is a schematic illustration of an exemplary implementation of a storage network;

FIG. 2 is a functional diagram illustrating an exemplary implementation of a user interface in a storage network;

FIGS. 3a and 3b are illustrations of an exemplary graphical user interface;

FIG. 4 is another illustration of an exemplary graphical user interface;

FIG. 5 is another illustration of an exemplary graphical user interface; and

FIG. 6 is a flowchart of exemplary operations to implement a user interface in a storage network.

### DETAILED DESCRIPTION

Briefly, an implementation of the invention includes a user interface that enables a network administrator to centrally manage access to the system devices in a storage system. In addition, the network administrator can generate logical maps and assign the logical maps to host connections without having to determine the physical layout of the storage system. If the layout of the storage system changes, the network administrator can readily update the logical map of the storage system without having to individually configure each of the internal routers. This and other implementations are described in more detail below with reference to the figures.

Exemplary System

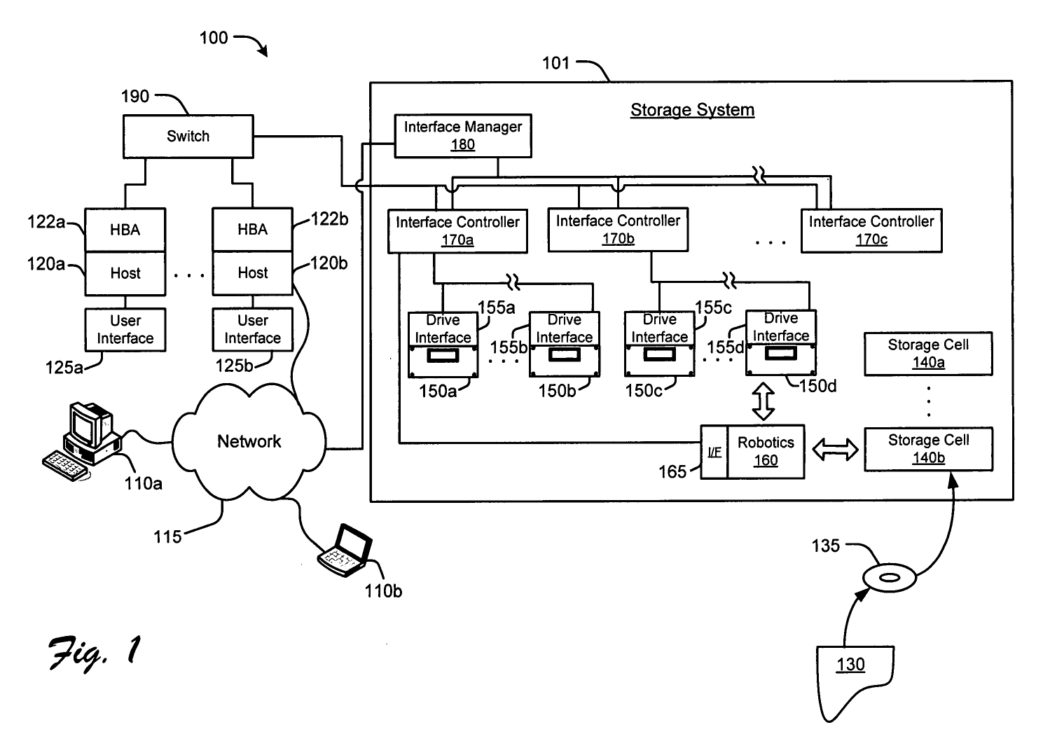

An exemplary storage area network (SAN), otherwise referred to as storage network 100, is shown in FIG. 1. The storage network 100 may be implemented in a private, dedicated network such as, e.g., a Fibre Channel (FC) switching fabric. Alternatively, portions of the storage network 100 may be implemented using public communication networks pursuant to a suitable communication protocol. Storage network 100 is shown in FIG. 1 including an automated storage system 101 which may be accessed by one or more clients 110a, 110b via at least one host 120a, 120b.

As used herein, the term “host” comprises one or more computing systems that provide services to other computing or data processing systems or devices. For example, clients 110a, 110b may access the storage device 101 via one of the hosts 120a, 120b. Hosts 120a, 120b include one or more processors (or processing units) and system memory, and are typically implemented as server computers.

Clients 110a, 110b can be connected to one or more of the hosts 120a, 120b or to the storage system 101 directly or over a network 115, such as a Local Area Network (LAN) and/or Wide Area Network (WAN). Clients 110a, 110b may include memory and a degree of data processing capability at least sufficient to manage a network connection. Typically, clients 110a, 110b are implemented as network devices, such as, e.g., wireless devices, desktop or laptop computers, workstations, and even as other server computers.

As previously mentioned, storage network 100 includes an automated storage system 101 (hereinafter referred to as a “storage system” ). Data 130 is stored in the storage system 101 on storage media 135, such as, magnetic data cartridges, optical media, and hard disk storage, to name only a few examples.

The storage system 101 may be arranged as one or more libraries (not shown) having a plurality of storage cells 140a, 140b for the storage media 135. The libraries may be modular (e.g., configured to be stacked one on top of the other and/or side-by-side), allowing the storage system 101 to be readily expanded.

Before continuing, it is noted that the storage system 101 is not limited to any particular physical configuration. For example, the number of storage cells 140a, 140b may depend upon various design considerations. Such considerations may include, but are not limited to, the desired storage capacity and frequency with which the computer-readable data 130 is accessed. Still other considerations may include, by way of example, the physical dimensions of the storage system 101 and/or its components. Consequently, implementations in accordance with the invention are not to be regarded as being limited to use with any particular type or physical layout of storage system 101.

The storage system 101 may include one or more data access drives 150a, 150b, 150c, 150d (also referred to generally by reference 150) for read and/or write operations on the storage medium 135. In one exemplary implementation, each library in the storage system 101 is provided with at least one data access drive 150. However, in other implementations data access drives 150 do not need to be included with each library.

Transfer robotics 160 may also be provided for transporting the storage media 135 in the storage system 101. Transfer robotics 160 are generally adapted to retrieve storage media 135 (e.g., from the storage cells 140a, 140b), transport the storage media 135, and eject the storage media 135 at an intended destination (e.g., one of the data access drives 150).

Various types of transfer robotics 160 are readily commercially available, and embodiments of the present invention are not limited to any particular implementation. In addition, such transfer robotics 160 are well known and further description of the transfer robotics is not needed to fully understand or to practice the invention.

It is noted that the storage system 101 is not limited to use with data access drives and transfer robotics. Storage system 101 may also include any of a wide range of other system devices that are now known or that may be developed in the future. For example, a storage system including fixed storage media such as a redundant array of independent disks (RAID), may not include transfer robotics or separate data access drives.

Each of the system devices, such as the data access drives 150 and transfer robotics 160, are controlled by interface controllers 170a, 170b, 170c. The interface controllers are operatively associated with the system devices via the corresponding device interfaces. For example, interface controller 170a is connected to drive interfaces 155a, 155b for data access drives 150a, 150b, respectively. Interface controller 170a is also connected to the robotics interface 165 for transfer robotics 160. Interface controller 170b is connected to drive interfaces 155c, 155d for data access drives 150c, 150d, respectively. Interface controller 170b is also connected to the robotics interface 165 for transfer robotics 160.

In an exemplary implementation, the interface controllers 170a, 170b, 170c may be implemented as Fibre Channel (FC) interface controllers and the device interfaces 155a, 155b, 155c, 155d may be implemented as small computer system interface (SCSI) controllers. However, the invention is not limited to use with any particular type of interface controllers and/or device interfaces.

Storage system 101 also includes an interface manager 180. Interface manager 180 is communicatively coupled, internally, with the interface controllers 170a, 170b, 170c, and aggregates device information and management commands for each of the system devices. The interface manager 180 also allocates the system devices as uniquely identified logical units or LUNs. Each LUN may comprise a contiguous range of logical addresses that can be addressed by mapping requests from the connection protocol used by the hosts 120a, 120b to the uniquely identified LUN. Of course the invention is not limited to LUN mapping and other types of mapping now known or later developed are also within the scope of the invention.

Interface manager 180 is also communicatively coupled, externally, to user interfaces 125a, 125b via hosts 120a, 120b and/or clients 110a, 110b. In an exemplary implementation, the hosts 120a, 120b are connected to the storage system 110 by I/O adapters 122a, 122b, such as, e.g., host bus adapters (HBA), to a switch 190. Switch 190 may be implemented as a SAN switch, and is connected to the storage system 101. Accordingly, the hosts 120a, 120b and/or clients 110a, 110b may access system devices, such as the data access drives 150 and transfer robotics 160, via the interface manager 180.

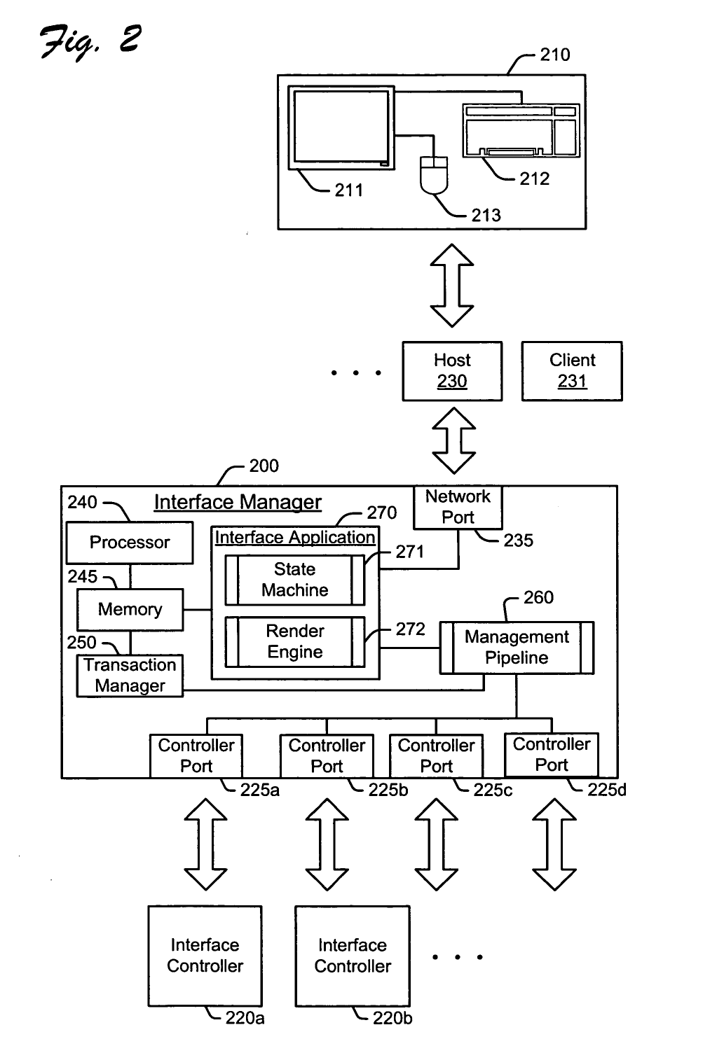

FIG. 2 is a functional diagram illustrating in more detail an exemplary interface manager 200 and user interface 210. Interface manager 200 and user interface 210 may be implemented in hardware, software and/or firmware which process computer-readable data signals embodied in one or more carrier waves. Interface manager 200 aggregates device information and management commands for a storage system (e.g., storage system 101 in FIG. 1). Interface manager 200 outputs device information and receives management commands via the user interface 210, thereby enabling a network administrator (or other user) to centrally manage access to the storage system.

Interface manager 200 communicatively couples interface controllers 220a, 220b to the user interface 210 via hosts 230 and/or clients 231. Accordingly, the interface manager 200 includes a plurality of I/O modules or controller ports 225a, 225b, 225c, 225d (also referred to generally by reference 225). The controller ports 225 facilitate data transfer between the respective interface controllers 220a, 220b. Interface manager 200 also includes at least one network port 235.

In an exemplary implementation, the controller ports 225 and network port(s) 235 may employ fiber channel technology, although other bus technologies may also be used. Interface manager 200 may also include a converter (not shown) to convert signals from one bus format (e.g., Fibre Channel) to another bus format (e.g., SCSI).

It is noted that auxiliary components may also be included with the interface manager 200, such as, e.g., power supplies (not shown) to provide power to the other components of the interface manager 200. Auxiliary components are well understood in the art and further description is not necessary to fully understand or to enable the invention.

Interface manager 200 may be implemented on a computer board and includes a processor (or processing units) 240 and computer-readable storage or memory 245 (e.g., dynamic random access memory (DRAM) and/or Flash memory). Interface manager 200 also includes a transaction manager 250 to handle all transactions to and from the interface manager 200, and a management pipeline 260 to process the transactions.

Implementations of a transaction manager and management pipeline are described in co-owned U.S. Patent Application for “INTERFACE MANAGER AND METHODS OF OPERATION IN A STORAGE NETWORK” of Maddocks et al. (Attorney Docket No. HP1-707US; Client Docket No. HP200315416-1), filed the same day as the present application and referenced above under the section entitled “Related Application,” hereby incorporated herein for all that it discloses. However, it is noted that the exemplary implementations shown and described therein are not intended to limit the interface manager of the present invention.

User interface 210 includes one or more output devices 211, such as, e.g., audio and/or video output. User Interface 210 also includes one or more input device, such as, e.g., a keyboard 212, pointing device 213, and/or microphone (not shown), to name only a few examples. User interface 210 is typically implemented at one or more of the hosts 230 and/or clients 231, although user interface 210 may be implemented at the storage system and/or at one or more clients (e.g., storage system 101 and/or clients 110a, 110b in FIG. 1).

User interface 210 is operatively associated with an interface application 270. In FIG. 2, the interface application 270 is shown residing at the interface manager 200, e.g., in memory 245 for execution by processor 240. It is noted, however, that interface application 270 and/or various functional modules thereof may reside on one or more other devices in a storage network.

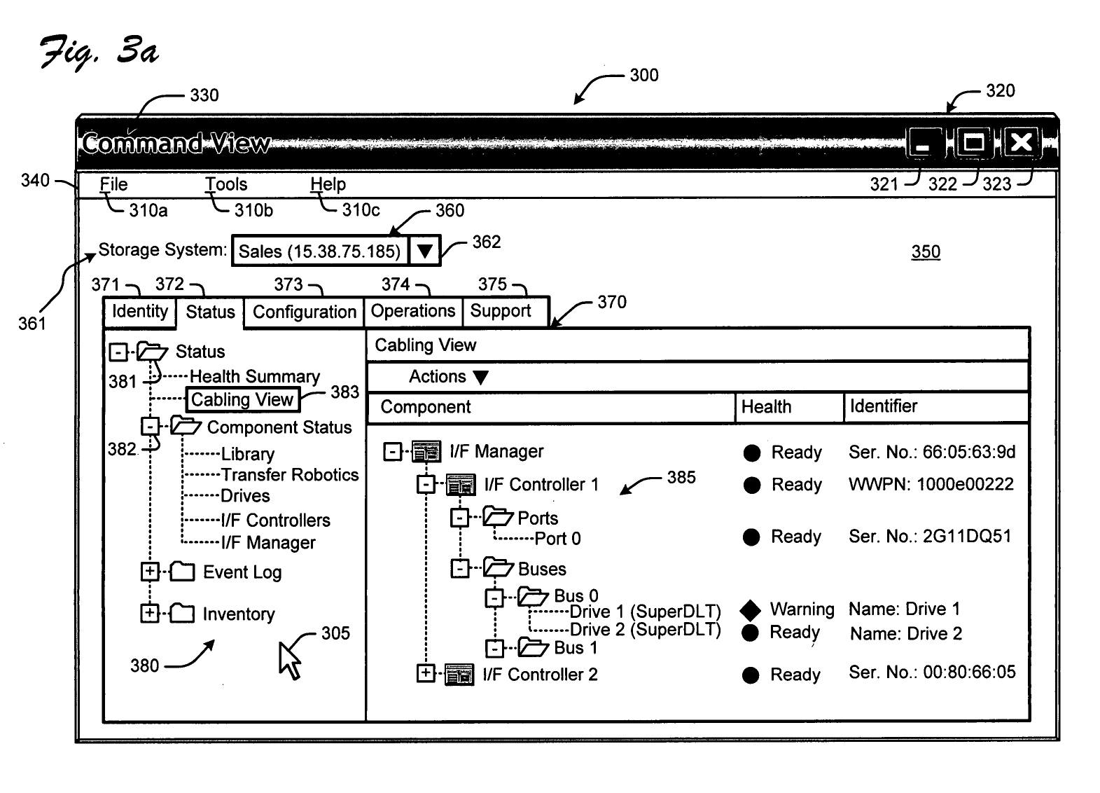

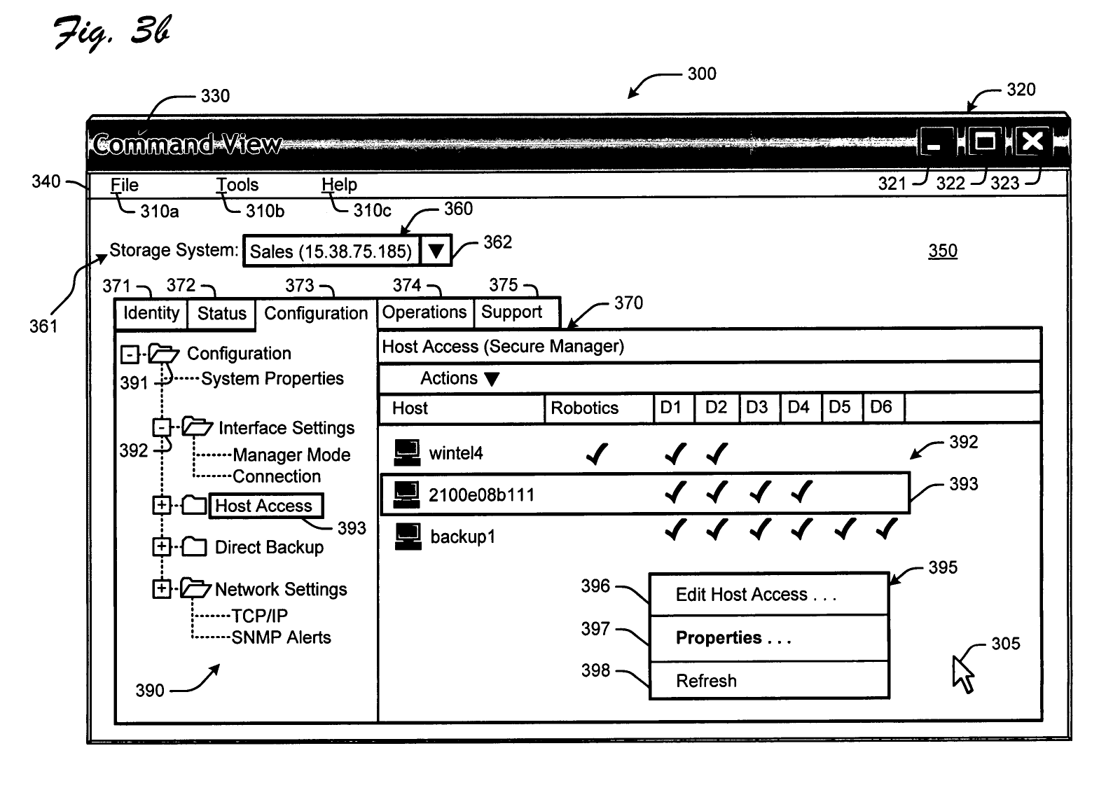

In an exemplary implementation, interface application 270 generates a graphical user interface (see e.g., FIGS. 3a and 3b) based at least in part on the device information and management commands in the management pipeline 260. Interface application 270 is implemented as software and/or firmware and is described herein as various functional modules, such as, e.g., a state machine 271 and a render engine 272.

State machine 271 determines the inventory and status of system devices connected to the interface controllers 220a, 220b (i.e., device information). State machine 271 also receives input from the user interface 210 (i.e., management commands). Render engine 272 formats output for the user interface 210, e.g., in response to processing device information and management commands by the state machine 271. For example, render engine 272 may format the inventory and status of devices connected to the interface controllers 220a, 220b and may also update the output at the user interface 210 in response to receiving management commands at the interface manager 200.

Before continuing, it is noted that the exemplary interface application 270 shown and described herein is merely for purposes of illustration and is not intended to be limiting. For example, state machine 271 and render engine 272 do not need to be provided as separate functional components. In addition, other functional components may also be provided and are not limited to a state machine and render engine.

FIGS. 3a and 3b are diagrammatic illustrations of an exemplary user interface that may be implemented in a storage network (e.g., the storage network 100 shown in FIG. 1). The exemplary user interface shown in FIGS. 3a and 3b is implemented as a graphical user interface 300 in a windows operating system environment (e.g., Microsoft Corporation's WINDOWS NT®). Of course other implementations are also possible and the user interface is not limited to use with any particular operating system.

Graphical user interface 300 is associated with an interface application (e.g., the interface application 270 in FIG. 2). The user may launch the graphical user interface 300 in a customary manner, for example, by clicking on an icon, selecting the program from a menu, or pressing a button on a keypad.

The graphical user interface 300 supports user interaction through common techniques, such as a pointing device (e.g., mouse, style), keystroke operations, or touch screen. By way of illustration, the user may make selections using a mouse (e.g., mouse 213 in FIG. 2) to position a graphical pointer 305 and click on a label or button displayed in the graphical user interface 300. The user may also make selections by entering a letter for a menu label 310a, 310b, 310c while holding the ALT key (e.g., “ALT+letter” operation) on a keyboard (e.g., keyboard 212 in FIG. 2). In addition, the user may use a keyboard to enter command strings (e.g., in a command window).

The graphical user interface 300 is displayed for the user in a window, referred to as the “application window” 320, as is customary in a windowing environment. The application window 320 may include customary window functions, such as a Minimize Window button 321, a Maximize Window button 322, and a Close Window button 323. A title bar 330 identifies the application window 320 (e.g., as “Command View” in FIG. 3). The application window 320 may also include a customary menu bar 340 having an assortment of pull down menus 310a, 310b, 310c (e.g., labeled “File”, “Tools”, and “Help”). For example, the user may select a print function (not shown) from the “File” menu 310a.

Application window 320 also includes an operation space 350. Operation space 350 may include one or more graphics for displaying output and/or facilitating input from the user. Graphics may include, but are not limited to, subordinate windows, dialog boxes, icons, text boxes, buttons, and check boxes. Exemplary operation space 350 is shown having a text box 360 and a subordinate window 370.

Exemplary text box 360 may be used to select a storage system (e.g., storage system 101 in FIG. 1), for example, if the user interface is operatively associated with a plurality of storage systems. The text box 360 is identified by text 361 (e.g., “Storage System”) and displays the selected storage system, e.g., by name and/or network address (e.g., “Sales (15.38.75.185)” in FIG. 3a). A user may change the selected storage system, e.g., by typing in the name and/or network address of another storage system or by clicking on button 362 to display a list of available storage systems.

Exemplary subordinate window 370 provides the user with a number of functions that are available through the graphical user interface 300, e.g., by selecting one of the menu tabs 371-375 (e.g., “Identity,” “Status,” “Configuration,” “Operations,” and “Support”).

Selecting the “Identity” menu tab 371 displays general information regarding the selected storage system (e.g., name, manufacturer, network address, number of interface controllers, number of data access drives, firmware version, etc.). Selecting the “Status” menu tab 372 displays status information regarding the selected storage system and is discussed in more detail below. Selecting the “Configuration” menu tab 373 displays configuration information regarding the selected storage system and is also discussed in more detail below. Selecting the “Operations” menu tab 374 displays functions that are available for the selected storage system (e.g., reboot, upgrade firmware). Selecting the “Support” menu tab 375 displays support information regarding the selected storage system (e.g., current firmware version, instructions to access available updates).

FIG. 3a illustrates selecting the “Status” menu tab 372 in application window 320, wherein a status tree 380 is displayed in subordinate window 370. Status tree 380 includes a number of nodes identifying various status functions that are available to the user for the selected storage system. The user may expand one or more parent nodes in the status tree 380 to “drill down” and view child nodes. The child nodes include further status operations that are available for the selected storage system.

A closed node may be displayed with a “+” symbol and an expanded node may be displayed with a “−” symbol. In FIG. 3a for example, the Status node 381 is expanded to show status functions (e.g., Health Summary, Cabling View, Component Status). Component Status node 382 is further expanded to show the components that may be selected (e.g., Library, Transfer Robotics).

In an exemplary implementation, selecting a status function displays additional information adjacent the status tree 380. For example, in FIG. 3a the user selected the Cabling View function 383 to show the physical connections, component health, and network identifier for the selected storage system (e.g., as connection tree 385).

FIG. 3b illustrates selecting the “Configuration” menu tab 373 in application window 320, wherein a configuration tree 390 is displayed in subordinate window 370. Configuration tree 390 includes a number of nodes identifying various configuration functions that are available to the user for the selected storage system. The user may expand one or more parent nodes in the configuration tree 390 to “drill down” and view child nodes. The child nodes include further configuration functions, as discussed in more detail above.

In an exemplary implementation, selecting a configuration function displays additional information adjacent the configuration tree 390. In FIG. 3b, the user selected the Host Access function 391 to show access permissions for the selected storage system. Access permissions may be displayed in table format (e.g., as table 392 in subordinate window 370). Table 392 includes a plurality of columns to identify hosts connected to the storage system, and the various system devices in the storage system.

Access permissions are indicated in table 392 by check marks. For example,.the host identified as “winte14” is shown configured for access to the transfer robotics and drives D1-D2, but without access to drives D3-D6. The host identified as “2100e08b111” is shown configured for access to drives D1-D4, but without access to the transfer robotics or drives D5-D6. The host identified as “backup1” is shown configured for access to all of the drives D1-D6, but without access to the transfer robotics.

A user may configure access permissions for one or more of the hosts by selecting a host from the Host Access table 392. For example, host “2100e08b11” is shown selected at 393 in FIG. 3b. The user may then right click the mouse button to display a menu 395 with various functions to configure the selected host.

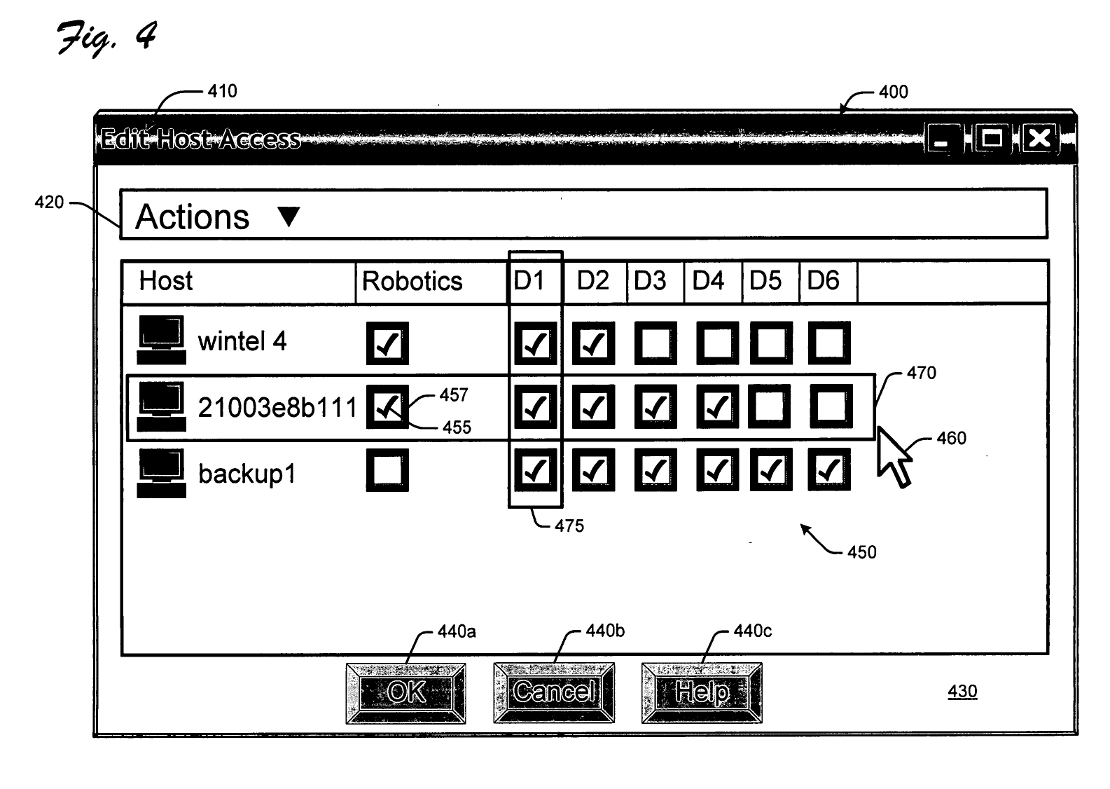

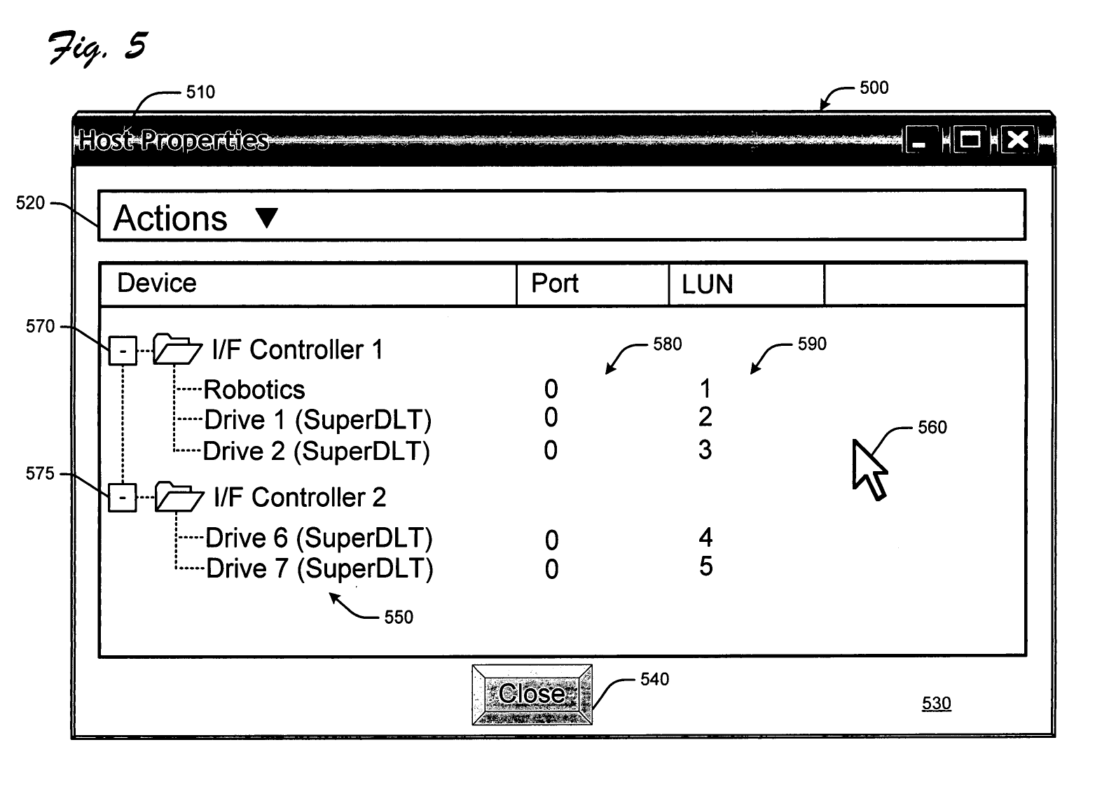

Menu 395 is shown including menu options 396, 397, 398. The user may select a menu option from menu 395 to configure access permissions for the selected host. The graphical user interface that is displayed in response to the user selecting menu option 396 (“Edit Host Access”) is illustrated in FIG. 4. The graphical user interface that is displayed in response to the user selecting menu option 397 (“Properties”) is illustrated in FIG. 5. Menu option 398 (“Refresh”) may be selected as is customary to refresh the display. Other menu options may also be included, such as, e.g., “Rename” and “Delete” (not shown).

FIG. 4 is a diagrammatic illustration of application window 400 that may be launched in response to the user selecting the “Edit Host Access” menu option from application window 320 in FIG. 3b. Application window 400 is also associated with an interface application (e.g., the interface application 280 in FIG. 2) and supports user interaction through common techniques, such as those discussed above.

Application window 400 may also include title bar 410 which identifies the application window, e.g., as “Edit Host Access.” Application window 400 may also include customary menu bar 420 with pull down menus (e.g., labeled “Actions”). For example, the user may select a refresh function (not shown) from the “Action” menu.

Application window 400 also includes an operation space 430. Operation space 430 may include one or more graphics for displaying output and/or facilitating input from the user. For example, operation space 430 includes customary function buttons 440a, 440b, and 440c labeled “OK,” “Cancel,” and “Help,” respectively.

Operation space 430 includes a host access table 450, which may be displayed in a subordinate window. Host access table 450 is configured in columns and rows identifying the various hosts and corresponding system devices in the selected storage system. Access permissions are displayed for the hosts (e.g., indicated with check marks 455). A user may configure one or more of the hosts for the selected storage system, for example, by selecting and deselecting devices corresponding to the host. For purposes of illustration, the user may move graphical pointer 460 to the Robotics checkbox and click the mouse button to place a check 455 in the checkbox 457. Accordingly, the host identified as “21003e8b111” is configured for access to the transfer robotics.

The user may also configure access permissions by selecting one or more rows and/or columns to grant or deny access for the hosts and/or system devices. In an exemplary implementation, the user may select one or more rows of system devices for a host (e.g., illustrated by outline 470 in FIG. 4). The user may right click to display a menu with options, such as, e.g., “select all” to grant the selected host access to all system devices, or “clear all” to deny the selected host access to all system devices. Other menu options may include “Copy,” “Paste,” and “Delete.” For example, the user may copy the access permissions for a first host selection to another host selection using the copy/paste functions. Similarly, the user may select one or more columns (e.g., illustrated by outline 475), for example, to clear all access permissions for the selected system device(s).

FIG. 5 is a diagrammatic illustration of another application window 500 that may be launched in response to the user selecting the “Properties” menu option from application window 320 in FIG. 3b. Application window 500 is also associated with an interface application (e.g., the interface application 280 in FIG. 2). Application window 500 includes a title bar 510 to identify the application window, e.g., as “Host Properties,” and customary menu bar 520. Application window 500 also includes an operation space 530 with a customary function button 540 labeled “Close.”

In FIG. 5, operation space 530 includes a device tree 550 having a number of nodes identifying various interface controllers (e.g., I/F Controller 1 and I/F Controller 2) that the host is configured to access. The user may expand one or more parent nodes in the device tree 550 (e.g., using graphical pointer 560) to “drill down” and view child nodes. For example, node 570 for Interface Controller 1 is expanded to show that the host has access to the Robotics, Drive 1, and Drive 2. Node 575 for Interface Controller 2 is expanded to show that the host has access to Drive 6 and Drive 7. The corresponding port 580 and LUN 590 assigned to the system devices are also displayed.

Graphical user interfaces shown in FIGS. 3a-b and 4-5 merely illustrate sample user interfaces, and are by no means exhaustive. It will be readily appreciated by those having ordinary skill in the art after having become familiar with the teachings of the invention that yet other user interfaces may also be readily implemented.

It is also noted that, although not shown in FIGS. 3a-b and 4-5, the application windows may also include other components. These components may include, without limitation, a status bar to indicate the status of the storage system and/or interface manager (e.g., connecting, searching for devices, etc.). Likewise, text and/or graphics displayed in the application windows may be highlighted when corresponding features are available or active, and may be “grayed out” when corresponding features are unavailable or inactive. Of course other implementations are also contemplated, such as displaying information in separate windows (e.g., in a “pop-up”).

Exemplary Operations

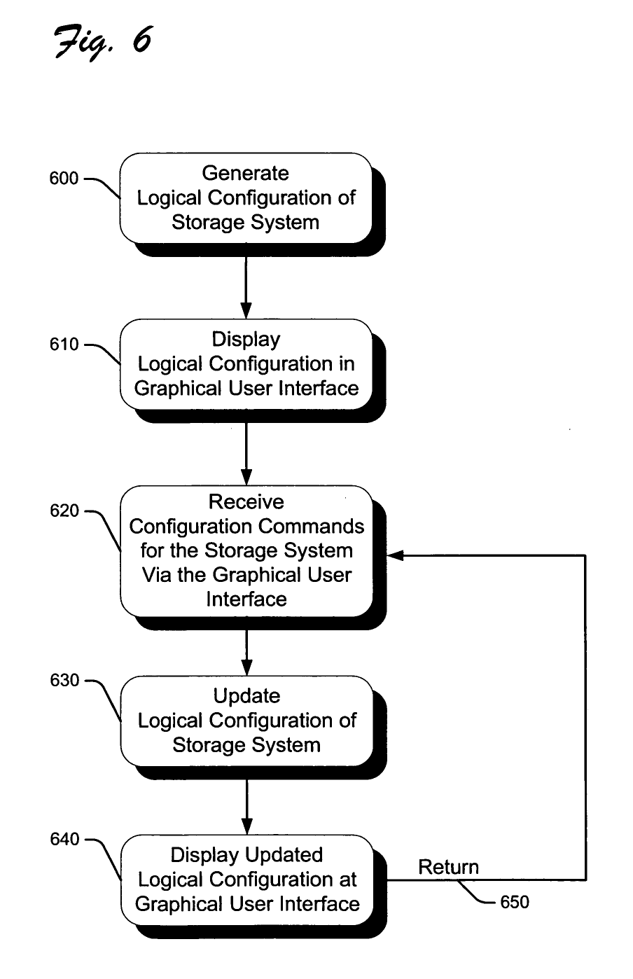

FIG. 6 is a flowchart illustrating exemplary operations to implement a graphical user interface in a storage network. In one embodiment, the operations may be implemented on a processor (or processing units) of the interface manager, such as processor 240 shown in FIG. 2. In alternate embodiments one or more of the operations described in FIG. 6 may be implemented at the interface controllers, hosts, or other processor (or processing units) in the storage network.

In operation 600, a logical configuration of the storage system is generated, for example, at the interface manager based on aggregated device information from the interface controllers. In an exemplary implementation, the logical configuration may include plurality of logical devices (also called logical units or LUNs) allocated within the storage system. Each LUN comprises a contiguous range of logical addresses that can be addressed by host devices by mapping requests from the connection protocol used by the host device to the uniquely identified LUN.

In operation 610, the logical configuration generated in operation 600 is displayed in a graphical user interface, for example, as illustrated in FIGS. 3a and 3b. In operation 620, configuration commands for the storage system are received via the graphical user interface. For example, a network administrator may configure access to one or more of the system devices as illustrated in FIG. 4.

In operation 630, the logical configuration of the storage system is updated. For example, the logical configuration may be updated to indicate that a host is granted access to the transfer robotics and another host is denied access to one or more of the data access drives, based on the configuration commands received during operation 620. Alternatively, the logical configuration may be updated to indicate that one or more of the system devices have been added to or removed from the storage system, based on the device information received from the interface controller(s). In operation 640, the updated logical configuration is displayed at the graphical user interface. Operations may then return to operation 520, for example, when the user makes another selection at the user interface.

It is noted that the exemplary operations shown and described with reference to FIG. 6 are not intended to limit the scope of the invention to any particular order. In addition, the operations are not limited to closed loop operations. In other exemplary implementations, operations may end (e.g., if the system is powered off). Still other implementations are also contemplated, as will be readily apparent to those skilled in the art after having become familiar with the teachings of the invention.

In addition to the specific implementations explicitly set forth herein, other aspects and implementations will also be apparent to those skilled in the art from consideration of the specification disclosed herein. It is intended that the specification and illustrated implementations be considered as examples only, with a true scope and spirit of the following claims.

1. A storage network comprising:
an automated storage system including data access drives and transfer robotics;
an interface manager communicatively coupled to each of the data access drives and transfer robotics, the interface manager aggregating configuration information for the data access drives and transfer robotics in the automated storage system;
an interface application provided in computer-readable storage at the interface manager, the interface application generating user interface rendering data for the configuration information; and
a graphical user interface operatively associated with the interface application, the graphical user interface outputting the configuration information in accordance with the user interface rendering data.

2. The storage network of claim 1 wherein the interface application receives the configuration information from a management pipeline at the interface manager.

3. The storage network of claim 1 wherein the interface application includes a state machine to determine a state of the data access drives and transfer robotics based at least in part on the configuration information.

4. The storage network of claim 1 wherein the interface application includes a render engine to generate the user interface rendering data.

5. The storage network of claim 1 wherein the graphical user interface displays a logical map of the data access drives and transfer robotics.

6. The storage network of claim 1 wherein the graphical user interface displays access permissions for the data access drives and transfer robotics in a table format.

7. The storage network of claim 1 wherein the graphical user interface receives user input to change access permissions for the data access drives and transfer robotics.

8. In an automated storage system linked to a graphical user interface including a display and a user interface selection device, a method comprising:
aggregating configuration information at an interface manager for a plurality of system devices in the automated storage system;
generating user interface rendering data at the interface manager; and
displaying the configuration information in an application window at the graphical user interface in accordance with the user interface rendering data.

9. The automated storage system of claim 8 wherein the method further comprises displaying the configuration information in the application window as a logical map of the system devices.

10. The automated storage system of claim 8 wherein the method further comprises displaying access permissions for the system devices in the application window.

11. The automated storage system of claim 8 wherein the method further comprises receiving user input in the application window and updating the application window based on the user input.

12. The automated storage system of claim 8 wherein the method further comprises receiving management commands for the system devices based on user input at the application window.

13. The automated storage system of claim 8 wherein the method further comprises copying all access permissions for a first host selection to a second host selection in the application window.

14. The automated storage system of claim 8 wherein the method further comprises removing all access permissions for at least one host selection in the application window.

15. The automated storage system of claim 8 wherein the method further comprises copying all access permissions for a first device selection to a second device selection in the application window.

16. The automated storage system of claim 8 wherein the method further comprises removing all access permissions for at least one device selection in the application window.

17. A method comprising:
aggregating configuration information for a plurality of system devices in a storage system;
generating user interface rendering data; and
displaying the configuration information as a logical map of the system devices at a graphical user interface in accordance with the user interface rendering data.

18. The method of claim 17 further comprising receiving user selections from the graphical user interface to edit access permissions to the system devices.

19. The method of claim 18 wherein the user selections include copying and pasting access permissions for a first host to a second host.

20. The method of claim 18 wherein the user selections include copying and pasting access permissions for a first system device to a second system device.
